(19) United States
(12) Patent Application Publication
(10) Pub. No.: US 2006/0062947 A1
(43) Pub. Date: Mar. 23, 2006

(54) Packaging material with energy cured, hotmelt-receptive coating and package made therefrom

(76) Inventors: Scott Huffer, Hartsville, SC (US); Jeffrey M. Schuetz, Florence, SC (US); Jon Weiner, Huntersville, NC (US)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/946,048

(22) Filed: Sep. 21, 2004

(51) Int. Cl. B32B 27/10

(52) U.S. Cl. 428/34.2; 428/35.2

(57) ABSTRACT

A hotmelt-receptive packaging material, a method of making the material and a package made therefrom are described. The hotmelt-receptive packaging material includes a barrier substrate and an energy cured coating applied substantially uniformly to the substrate. The coating includes a polymerized network of oligomers and monomers, and a functional wax slip additive copolymerized with the network. The coating is receptive to hotmelt adhesive. A package can be formed from the material by wrapping it into a tubular structure with overlapping opposed edges and applying hotmelt adhesive to at least one of the opposed edges so that the hotmelt adhesive contacts the coated side of at least one of the edges and adheres the overlapped opposed edges.

### FIELD OF THE INVENTION

The invention relates to packages that are formed using hotmelt adhesive.

### BACKGROUND OF THE INVENTION

Certain packages, such as paper candy bar sleeves, are formed using a bead of hotmelt adhesive. The sleeve can be wrapped round the product and the hotmelt adhesive used to seal overlapping edges of the packaging material. It is also known to seal certain bags and the like with hotmelt adhesive.

A recent development in the packaging industry is the use of energy cured coatings. These coatings can be applied as a liquid and then cured by ultra-violet energy (“UV”) or an electron beam (“EB”). The curing process polymerizes the energy curable coatings, converting them from a liquid to a solid substantially instantly. The coatings can be formulated to form tough, abrasion resistant, overlacquers. At the same time, they can be formulated to have high gloss and excellent clarity, making them ideal for use as a protective layer over surface printed packaging. For many applications, EB cured coatings have become preferred over UV cured coatings because EB cured coatings are cured by free radical polymerization. That is, they are polymerized and crosslinked directly by high energy electrons, requiring no photoinitiators or other potentially volatile components. For many of these reasons, packages produced with EB cured coatings have enjoyed commercial success in recent years.

Packages that include energy cured coatings are described in several commonly owned U.S. Patent Applications. U.S. patent application Ser. No. 09/778,334 describes a cold-seal package having an energy cured coating; U.S. patent application Ser. No. 09/920,084 describes coffee packaging with an energy cured coating; and U.S. patent application Ser. No. 09/826,236 describes a gum wrapper with an electron beam cured coating.

Given the advantages of energy cured coatings in the packaging industry, it would be desirable to use the coatings for packages that are formed using hotmelt adhesive. However, there has been difficulty in adapting energy cured coatings for use in a package that is formed with hotmelt adhesive. Specifically, it has been found that when hotmelt is applied to known energy cured package coatings, the hotmelt adhesive has a tendency to fail. It is believed that migratory silicone release agents, which are incorporated into the coatings to provide appropriate coefficients of friction for use in processing equipment, inhibit the bonding of the hotmelt adhesive.

One way to overcome the problem of migratory silicone agents inhibiting the hotmelt adhesive is to pattern apply the energy curable coating onto the substrate. The pattern application avoids placing the coating on locations where the hotmelt is to be applied. However, pattern applying the energy curable coating is costly and labor intensive because a cylinder must be specially engraved for each type of packaging material to be produced. The cost associated with pattern applying the energy curable coating is prohibitive for many applications, especially those involving limited quantities of product. Also, a smoothing bar cannot be used during production to enhance the gloss of a pattern applied coating. Thus, it is generally not practical to utilize energy cured coatings in hotmelt packaging applications.

A method of producing a package with a flood coated or otherwise substantially uniform, energy cured coating for hotmelt applications is needed.

### SUMMARY OF THE INVENTION

The invention relates to a hotmelt-receptive packaging material having a barrier substrate and an energy cured coating. The energy cured coating includes a polymerized network of oligomers and monomers, and a functional wax slip additive copolymerized with the network. The coating can be a transparent, high gloss coating for protecting an image printed between the coating and the barrier substrate. The coating is receptive to hotmelt adhesive. Thus, the coating can be applied substantially uniformly onto the substrate without the need for pattern applying the coating.

The invention also relates to a package formed from the packaging material. The package includes a barrier substrate coated substantially uniformly with a non-migratory (i.e., cross linked with the polymer) silicone energy cured coating having a polymerized network of oligomers and monomers, and a functional wax slip additive copolymerized with the network. The coated barrier substrate is wrapped into a tubular structure with overlapping opposed edges to form a package. A hotmelt adhesive is applied to at least one of the opposed edges. The hotmelt adhesive contacts the coated side of at least one of the edges and adheres the overlapped opposed edges.

The invention also relates to a method of making a printed package and the printed package thereby made. According to the method, an image is printed on a barrier substrate. An energy curable coating having a functional wax slip additive is coated over the printed image and cured to form packaging material. During the curing step, the functional wax slip additive becomes copolymerized in the coating. The packaging material is formed into a package by applying a bead of hotmelt adhesive adjacent an edge of the coated barrier substrate and wrapping the packaging material into a tubular structure so that the bead of hotmelt adhesive is disposed between opposed overlapping edges and in contact with the coated side of at least one of the edges. The hotmelt adhesive adheres the opposed overlapping edges.

### BRIEF DESCRIPTION OF THE DRAWINGS

For the purpose of illustrating the invention, there are shown in the drawings forms which are presently preferred; it being understood, that the invention is not limited to the precise arrangements and instrumentalities shown.

FIG. 1 is a cross-sectional view of a packaging material according to an embodiment of the invention.

FIG. 2 is a schematic representation of production apparatus for making a packaging material according to an embodiment of the invention.

FIG. 3 is a view of a package according to an embodiment of the invention.

### DETAILED DESCRIPTION OF THE DRAWINGS

In the Figures, in which like numerals indicate like elements, there are shown preferred embodiments of a packaging material, production apparatus for making the material and a package produced from the material. The preferred packaging material 10 includes a barrier substrate 12, a printed image 14 and an energy cured coating 16. If desired, the packaging material 10 can also include short-run printing 18 over the energy cured coating 16.

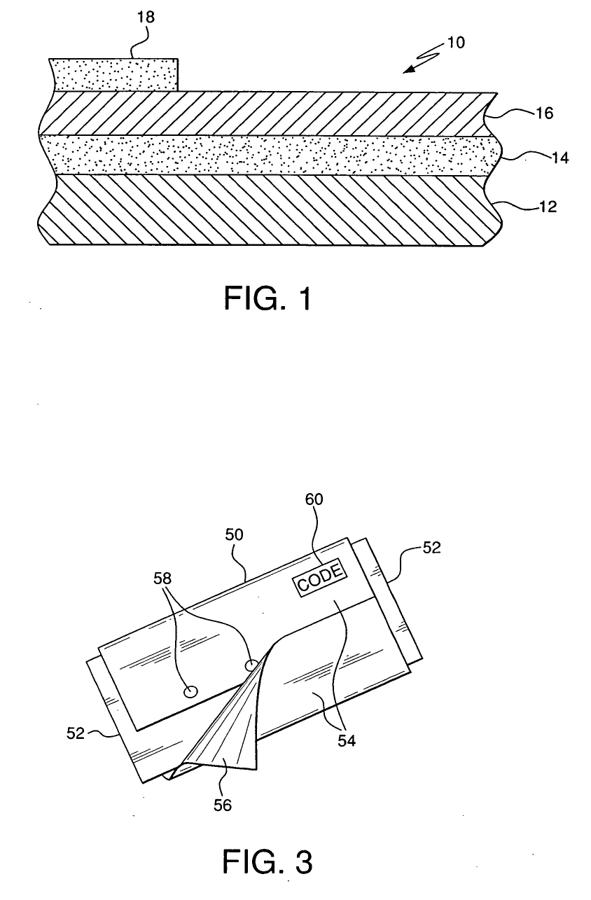

If the packaging material 10 is to be used as a sleeve for a candy bar or the like, a preferred material for the barrier substrate 12 is paper. If the packaging material is to be used as a cookie bag or the like, the barrier substrate can be paper with a coating of polypropylene or polyethylene. The polypropylene coating (not shown) would be provided on the inside of the completed bag, and on the side of barrier substrate 12 opposite the layer 14 in FIG. 1. Suitable paper for the barrier substrate 12 includes 25 to 50 pound bleached paper. Paper is relatively inexpensive, yet provides the packaging material 10 with good bulk and strength. However, it is also possible to use other materials or combinations of materials known for making packaging. Alternative materials for the base substrate include plastic, such as high density, medium density, low density or linear low density polyethylene, polypropylene homopolymers or copolymers, polyesters, nylons, vinyl based materials, etc. The base substrate can include laminations or coated materials, metallized layers, foil layers, and other gas or moisture barrier layers, such as inorganic oxides, polyvinylidene chloride, ethylene vinyl alcohol or the like. It is also possible to include other heat sealable layers.

The base substrate is preferably printed with an image or ink layer 14. The image 14 can be printed with solvent-based or water-based ink. The image could alternatively be printed with UV or EB cured ink if desired. It is contemplated that the image include attractive graphics, as is known in the industry, and other indicia that is not sensitive to the date of manufacture or temporary events, such as promotions, so that the image can be repeatedly printed over a long period of time without making new printing cylinders. Such indicia can include nutritional information, promotional materials, pricing information, etc. Because the printed image 14 is not frequently changed for a particular packaging application, it will sometimes be referred to herein as “long-run” printing.

The energy cured layer 16 is a high gloss, transparent coating that provides scuff and abuse resistance to protect the printed image 14. The energy cured layer 16 is a polymerized network of oligomers and monomers, and a functional wax slip additive copolymerized with the network. The terms “copolymerized”, “copolymerize” and the like, refer to the state of being or the act of becoming bonded to the polymer network, not necessarily bonded together as a long chain of like monomers. As such, a “copolymerized” unit can be bonded to the polymer network as a single unit side branch.

Other additives can also be included in the coating. Photoinitiators are required if the energy cured coating is to be curable by UV. However, the preferred coating is EB curable, and the EB curing mechanism will be, accordingly, referred to from time to time below. The preferred oligomers are epoxy or polyester acrylates. The preferred monomer is an acrylate. The monomers can act as diluents, used to reduce the viscosity of the coating for application purposes. The concentration of monomer is adjustable to provide a wide range of viscosity, such that many conventional coating systems may be employed to apply the energy curable coating. The blend ratio of oligomer and monomer also controls physical properties and adhesion of the coating.

The functional wax slip additive in the coating, which improves the coefficient of friction, can be a polyethylene or polypropylene synthetic wax that includes a functional group having a carbon double bond. The carbon double bond breaks under an ionizing beam of accelerated electrons and reacts with the oligomer to become fixed or “reacted-in” during crosslinking of the electron beam curable coating. Such functional groups are preferably acrylates. However, other known functional groups may also be suitable. The exact chemical structure of the functional wax slip additive can depend on the oligomer component of the coating. Given the disclosure of the present application, suitable coatings having functional wax slip agents can be formulated by those skilled in the art of energy curable coatings. The critical requirement of the functional group is that it contains a carbon double bond, which will allow the wax to chemically react into the oligomer/monomer network and become fixed in the curing process.

Various additional additives, the exact nature of which will depend on the specifications of the package to be produced, may also be included in the energy curable coating formulation. It is known to provide additional additives, such as defoamers and wetting agents to polymer films to improve, for example, gloss and processing qualities. The additional additives can also include functional groups so as to react into the oligomer/monomer network during curing. The stability of the energy curable coating allows for excellent control of the gloss and slip qualities of the packaging material 10, allowing a manufacturer to create packaging according to demanding specifications.

A suitable electron beam curable coating formulation, which is presently preferred for producing the energy cured layer 16, is sold by Sovereign Specialty Chemicals, Inc. of Buffalo, N.Y. and identified by the formulation number EB 1040E. The electron beam curable coating with a functional wax slip additive not only has an excellent appearance, but is also receptive to hotmelt adhesive, other adhesives and inks. Examples of packages that can be produced using EB1040E are described below.

Because the energy cured coating 16 is receptive to ink, as well as hotmelt adhesive, short-run printing 18 can be printed on the coating 16. As explained more fully below, short-run printing, such as date stamps or promotional items, can be modified or removed entirely without the need to engrave new plates or cylinders that are used to print the long-run printing of image 14.

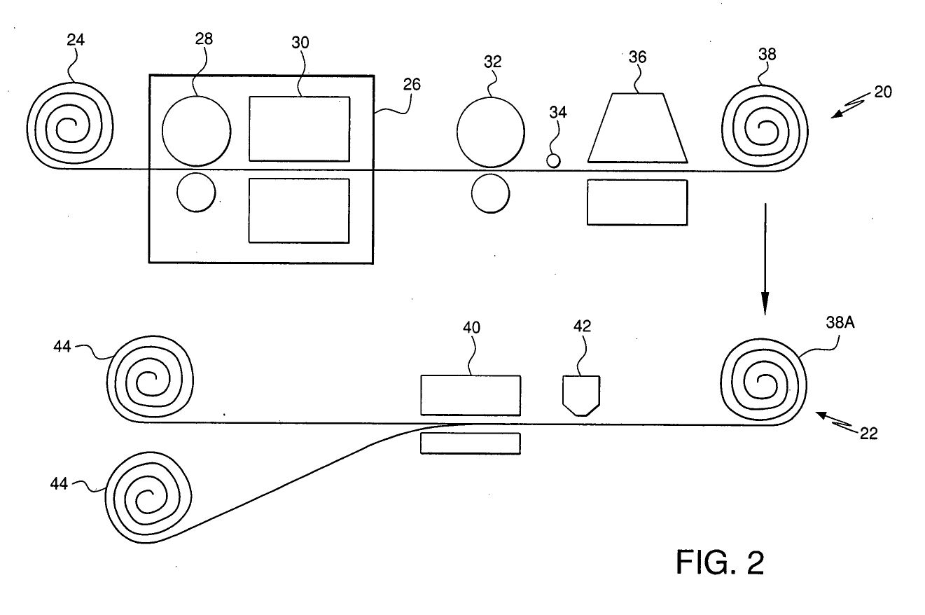

The packaging material 10 can be produced using production apparatus as represented schematically in FIG. 2. The production apparatus can includes a printing and coating line 20 and a slitting line 22.

A supply roll 24 of barrier substrate material is set up on an unwind stand. The supply roll 24 is unwound and the web of barrier substrate is passed through one or more printing stations 26, each of which includes an ink application cylinder 28 and a dryer 30. Only one printing station 26 is shown in FIG. 2. However, it should be understood that the use of two or more printing stations 26 is contemplated, depending on the number of colors to be printed. The film is preferably surface printed with any acceptable printing technique, such as by flexographic or rotogravure printing units, to provide the printed image 14. The printing applied at the stations 26 includes graphics and indicia that are generally not changed for a relatively long period of time so that the same flexo plates or gravure cylinders can be used. Such graphics and indicia can include those used to identify the source of the goods to be packaged. The printed image may also contain nutritional information or other facts relevant to a potential purchaser, such as price. Ideally, the printed image is eye catching and attractive to the consumer, thereby enticing a sale of the goods to be packaged.

The EB curable coating can be applied, after the ink is dried, by passing the printed barrier substrate web through an electron beam curable coating application station 32, where the EB curable coating is flood coated onto the barrier substrate. The flood coating provides a substantially uniform layer of EB curable coating, thereby sandwiching the ink layer between the EB curable coating and the barrier substrate. The EB curable coating can be applied from about 1.5 to about 2.5 pounds per ream. Most conventional coating units, such as flexo or gravure units, can be used to apply the EB curable coating. For large scale operations, direct gravure is an appropriate coating method.

Because the EB curable coating is applied in a substantially uniform layer, and not pattern applied, a smoothing bar 34 can be used to increase the gloss of the coating. The coating can then be cured using a suitable electron beam source 36 to provide the energy cured coating 16 (FIG. 1). Suitable electron beam sources include apparatus that can be obtained commercially from Energy Science, Inc. of Wilmington, Mass. Such an apparatus is described in U.S. Pat. No. 6,426,507 to Rangwalla et al., which is incorporated herein by reference.

The amount of energy absorbed during the curing process, also known as the dose, is measured in units of MegaRads (“MRads”) or kiloGrays (“kGy”), where one MRad is 10 kGy, one kGy being equal to 1,000 Joules per kilogram. The preferred dosage is from 2.0 to 4.0 MRads, more preferably from 2.5 to 3.5 MRads and most preferably about 3.0 MRads. The electron energy output of the electron beam source is preferably within the range of 90 keV to 150 keV and more preferably within the range of 115 keV to 125 keV.

When exposed to an electron beam from a suitable source, the materials in the coating polymerize and/or crosslink. Monomer reacts with the oligomer chains to form a crosslinked network. As already noted, the functional wax slip additive in the coating also reacts with and bonds to the chains to become reacted into the network. The precursor molecules are excited directly by the ionizing electron beam. Therefore, no photoinitiator compounds are required, so no residual volatile organic compounds are present in the finished product. Moreover, curing is substantially instantaneous and provides a cure percentage at or near one hundred percent. It has been found that an EB curable coating can be processed at manufacturing speeds in excess of 1000 feet per minute (5.08 m/sec).

After passing through the electron beam source 36, the printed and coated barrier substrate web can be wound on a take-up roll 38. The web of barrier substrate that is printed and coated on the printing and coating line 20 is preferably wider than the material needed to produce a single package so that two or more packages can be produced across the web (transverse direction). When one or more package images are produced across the web, the take-up roll 38 can be moved to the slitter line 22, where it becomes a supply roll 38A for the slitter line 22. The slitter line includes a slitter 40 and a conveniently programmable printer 42, which can be attached in front or behind the slitter 40. The printed and coated barrier substrate web can be unwound from the supply roll 38A and run through slitter 40 and the programmable printer 42.

The programmable printer 42 can be an ink jet printer, or other printer than can accept instructions for printing indicia 18 (FIG. 1) that may change frequently, relative to the long-run image printed at stations 26. Such indicia can include a date stamp or a promotional message that is to be displayed only for a limited time. Because the energy cured coating 16 is receptive to ink, the short-run printing can be printed directly onto the energy cured coating 16. The instructions provided to the programmable printer 42 can be changed easily, so the short-run printing can be updated or modified as frequently as desired for little cost.

The slitter 40 slits the packaging material into widths of single-package size. The number of single-package-sized webs produced will depend on the size of the individual packages being produced and the width of the printed and coated web. The single-package-sized webs can then be taken up on take-up rolls 44. The rolls 44 can be shipped to a producer or packager of the appropriate goods. Alternatively, the rolls 44 can be used to pre-make bags or other packages for shipment to the producer.

A package can be formed from the packaging material 10 by wrapping it into a tubular structure with overlapping opposed edges. The overlap can be formed by contacting the coated side (coating 16) of the first opposed edge and the uncoated side of the second opposed edge (barrier substrate 12). A bead, in the form of a line or one or more drops, of hotmelt adhesive can be applied to one of the edges in order to adhere the overlapping edges. Because the energy cured coating 16 is receptive to the hotmelt adhesive, it is not necessary to form a fin seal to provide contact between the barrier substrate layers of the opposed edges.

An example of such a package is shown in FIG. 3. The package is a candy bar sleeve 50 formed from packaging material 10. The sleeve 50 is wrapped around a candy bar that has first been enclosed in foil 52 or the like. The outside 54 of the sleeve is the energy cured layer 16, through which the printing 14 can be seen. In FIG. 3, the sleeve 50 is partially pulled back to reveal the inside 56 of the sleeve, which is the barrier substrate 12. Also revealed are beads of hotmelt adhesive 58 disposed between the outside 54 and inside 56 of the respective overlapping edges. If desired, short-run printing, such as a date code 60, can be disposed on the outside 56 of the sleeve 50.

Another example of a package according to the invention is a cookie bag with hotmelt adhesive sealing the overlapped edges of the bag. Such a bag can be a tin-tie type bag, which can have a barrier substrate of paper and a coating of polypropylene or polyethylene on the inside. The longitudinal edge of the bag can be sealed using hotmelt, rather than a water-based glue. Of course, other packages of various configurations can also be formed using the packaging material described herein.

### WORKING EXAMPLE

A packaging material according to an embodiment of the invention was produced as follows. A web of forty pound bleached paper was gravure printed with a solvent-based ink and dried. An electron curable coating with a functional wax slip additive, EB1040E, was obtained from Sovereign Specialty Chemicals. The coating was applied to the paper web at 2.0 pounds per ream (with a margin of error of +/−0.2) using an offset gravure coating unit with a 150 lines per inch (about 59 lines per cm) quadrilateral cell anilox roller. The anilox roller was set at a speed of 218 and a rubber offset roller was set at a speed of 200. The coating was smoothed using a 2 inch chrome smoothing bar rotating in the opposite direction of the web at a speed setting of 250. The coating was cured at an energy setting of 165 keV and a dosage of 3 MRads in a nitrogen flushed environment with an oxygen reading of 250 parts per million. The web was cured while running at a speed of 250 feet per minute (1.27 m/sec).

The printed and cured web was tested for various physical properties using standard testing methods. The final coat weight was found to be 2.1 pounds per-ream. An MEK (methyl ethyl ketone) rub test was successfully performed above 10 passes, demonstrating good curing of the coating. The coefficient of friction of the coated side of the web was determined to be 0.2 coating to metal (stainless steel) and 0.35 against itself. A tape adhesion test using 610 tape was performed against the coating, and resulted in fiber tear. The gloss of the cured coating, as measured by a gloss meter at a setting of 60 degrees, was measured at 85 gloss units.

A variety of modifications to the embodiments described will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

What is claimed is:

1. A hotmelt-receptive packaging material comprising:
a barrier substrate and an energy cured coating, the coating comprising
a polymerized network of oligomers and monomers, and
a functional wax slip additive copolymerized with the network.

2. The hotmelt-receptive packaging material of claim 1 wherein the barrier substrate is paper.

3. The hotmelt-receptive packaging material of claim 1 wherein the coating is applied substantially uniformly to the barrier substrate.

4. The hotmelt-receptive packaging material of claim 1 wherein the energy cured coating is a high gloss, transparent coating.

5. The hotmelt-receptive packaging material of claim 4 further comprising printing between the barrier substrate and the energy cured coating.

6. The hotmelt-receptive packaging material of claim 1 further comprising short-run printing on the energy cured coating.

7. The hotmelt-receptive packaging material of claim 1 wherein the energy cured coating is an electron beam cured coating.

8. A package comprising:
a barrier substrate coated substantially uniformly with an energy cured coating comprising a polymerized network of oligomers and monomers, and a functional wax slip additive copolymerized with the network;
the coated barrier substrate being wrapped into a tubular structure with overlapping opposed edges; and
a hotmelt adhesive adhering the overlapped opposed edges.

9. The package of claim 8 wherein the hotmelt adhesive is disposed between the coated side of the first opposed edge and a side of the second opposed edge that is not coated with the energy cured coating.

10. The package of claim 8 wherein the energy cured coating is a high gloss, transparent coating.

11. The package of claim 8 further comprising printing between the barrier substrate and the electron beam cured coating.

12. The package of claim 8 wherein the barrier substrate comprises paper.

13. The package of claim 8 wherein the energy cured coating is an electron beam cured coating.

14. The package of claim 8 further comprising short-run printing on the energy cured coating.

15. A package produced by a process comprising the steps of:
printing an image on a barrier substrate;
coating the printed side of the barrier substrate with an energy curable coating having a functional wax slip additive;
curing the coating with an energy source, the functional wax slip additive becoming copolymerized in the coating;
applying a bead of hotmelt adhesive adjacent an edge of the coated barrier substrate;
wrapping the coated barrier substrate into a tubular structure so that the bead of hotmelt adhesive is disposed between opposed overlapping edges and in contact with the coated side of at least one of the edges; and
adhering the opposed overlapping edges with the bead of hotmelt adhesive.

16. The package of claim 15 wherein the energy cured coating is high gloss and substantially transparent.

17. The package of claim 16 wherein the process of producing the package further comprises the step of smoothing the coating with a smoothing bar prior to curing the coating.

18. The package of claim 15 wherein the process of producing the package further comprises the step of printing indicia on the energy cured coating with a programmable printer.

19. The package of claim 15 wherein the barrier substrate comprises paper.
